(19) United States
(12) Patent Application Publication
(10) Pub. No.: US 2017/0263396 A1
(43) Pub. Date: Sep. 14, 2017

(54) High Voltage Disconnection Telescopic Switch Insulated by Air With a Moving Contact with Pressure Supply

(71) Applicant: Mikhail Sotnikov, Saint Bruno (CA)

(72) Inventor: Mikhail Sotnikov, Saint Bruno (CA)

(21) Appl. No.: 15/529,889

(22) PCT Filed: Nov. 26, 2015
(86) PCT No.: PCT/CA2015/051237

§ 371 Date: May 25, 2017

(30) Foreign Application Priority Data
Nov. 26, 2014 (MX) MX/A/2014/014431

(51) Int. Cl. H01H 31/02; H01H 31/32

(52) U.S. Cl. CPC H01H 31/026; H01H 31/32; H01H 2201/022; H01H 2203/036

(57) ABSTRACT

This invention makes reference to interrupter high voltage air-insulated telescopic disconnection switch with moving contact for supplying pressure, consisting of: a first male conductor comprising a first guide-positioner means internally coupled with such first male conductor via an intermediate section, a plurality of double-sided contact plates peripherally coupled with the intermediate section border; a second female conductor coaxially separated from the first male conductor comprising a second guide-positioner means internally coupled with such second female conductor by an intermediate section; a plurality of double-sided contact plates peripherally coupled with the intermediate section border; a moving conductor consisting of guide means internally coupled with such moving conductor by an intermediate support, being such conductor mobile and coaxially coupled with the interior of the first male conductor, where it moves to an open position, and is separated from the first male conductor and to a close position where such moving conductor causes a contact between the first male conductor and the second female conductor, by interacting among themselves to the first guide-positioner means of the first male conductor, the second guide-positioner means of the second female conductor and the guide means of the moving conductor; a plurality of contact plates peripherally coupled with the intermediate support border of the moving conductor, each of such contact plates having contact means for supplying pressure.

### CROSS REFERENCE TO RELATED APPLICATIONS

This application is a 371 of International Application No. PCT/CA2015/051237 filed Nov. 26, 2015, which claims priority to Mexican Patent Application No. MX/a/2014/014431 filed Nov. 26, 2014, the disclosures of which are incorporated herein by reference in their entirety.

### TECHNICAL FIELD OF THE INVENTION

This invention aims to electrical switching devices and, especially, to high voltage and high current disconnection telescopic switches for isolated phase busbars of a power generating station.

### INVENTION BACKGROUND

The high voltage disconnection telescopic switches are an essential part of isolated phase busbar systems for power stations. They are installed within the isolated phase busbars and are designed to isolate different sections of the mesh within the power station.

Usually, a high voltage telescopic switch consists of a female lead connector, a male lead connector and a cylindrical moving contact, all of them coaxially installed. The electrical connection takes place among the three essential components by the number of individual contact fingers disposed outside the circumference of the female and male lead connectors.

The contact force can be supplied by different spring systems including the one for the individual coil and flat spring or by means of mutual tension springs. In the open position, the moving part is located within the male lead connector.

For the purpose of making a physical separation or a contact between both moving lead connectors, the connector moves between the male and female lead connectors in a linear movement manner. The bars of the busbars in which the telescopic switches are installed in might be cylindrical or polygonal, and the contact systems are based on cylindrical constructions.

The usual number of interfaces for electrical contacts is 4; from the female lead connector to the contact finger, from the contact finger to the moving contact, from the moving contact to the finger contact and from the contact finger to the male lead connector.

The electrical contacts between the moving contact and the contact fingers slip off with the interruption of a physical link; the electrical contacts between the female and male lead connectors, and the fingers are stable without the interruption of a physical link. The female and male lead connectors are commonly made of aluminum alloys, moving connectors can be manufactured with copper or aluminum alloys and the finger contacts are manufactured with copper alloys. The size and weight of the contact switches and its layout within the isolates phase busbar make it difficult to replace the female and male lead connectors in the event of any damage caused by the electric arc or wear. The disconnection telescopic switch must have a minimum number of contact interfaces, a low transition resistance, a low operating force, without contact wear, a short-circuit rating and a high rated current, a corrosion resistant construction, capacity to withstand thermal shock; it has to be capable of adjusting light misalignments and with a capacity to be easily inspected and replaced.

### SUMMARY OF THE INVENTION

In one aspect, the invention provides a high voltage disconnection telescopic switch insulated by air with moving contact with pressure supply, which comprises: a main male conductor (1) consisting of a first guide-positioner (4) internally coupled to that main male conductor (1) by an intermediate plate (1a), a plurality of plates of double-sided contact (1b) peripherically coupled to the intermediate plate border (1a); a second female conductor (2) coaxially separated from the first male conductor (1) comprising a second guide-positioner means (5) internally coupled to such second female conductor (2) by an intermediate section (6), a plurality of plates of double-sided contact (1b) peripherically coupled to the intermediate section border (6); a mobile conductor (3) consisting of guide means (31, 33a, 33b) internally coupled with that conductor (3) by an intermediate support (30), said mobile conductor (3) being coaxially copied to the interior of the first male conductor (1); where such mobile conductor (3) moves between an open position, where such mobile conductor (3) is separated from the first male conductor (1), and a closed position where such mobile conductor (3) causes a contact between the first male conductor (1) and the second female conductor (2), by means of interacting among them from the first guide-positioner means (4) of the first male conductor (1), the second guide-positioner means (5) of the second female conductor (2) and the guide means (31, 33a, 33b) of the mobile conductor (3); and a plurality of contact plates (35) peripherically coupled to the intermediate support border (30) of the moving conductor (3), each of the contact plates (35) having means for supplying pressure (35a, 35b).

With the structural and technical features of this invention, the following aims are pursued:

The first aim of the invention is to supply a high voltage disconnection telescopic switch isolated by air for isolated-phase bus, which allows a rapid change of the parts for the electrical contacts without removing the telescopic disconnection switch from the isolated-phase bus. The female lead connector of the modular construction, the male lead connector and the moving contact will allow the replacement of any part which may be subject to catastrophic failure without removal of the disconnection telescopic switch off the facilities.

Another aim of this invention is to provide a disconnection telescopic switch with only two interfaces of moving contact. The moving aluminum contact fingers for supplying pressure are mechanically fixed to the intermediate support of the regularly polygonal shape to provide the required slide to the contact fingers.

Another aim of this invention is to provide a disconnection telescopic switch with polygonal flat contact surfaces which allow to obtain a reliable line contact between the contact plates and the contact fingers of reduced aluminum section.

Another aim of this invention is to provide a disconnection telescopic switch with independent contact fingers. The use of identical connectors will help to avoid installation errors and minimize the number of different components in the assembly.

Another aim of this invention is to provide a disconnection telescopic switch with a construction which removes pressure to the finger contact during displacement and enables the reduction of the mechanical wear of interfaces and the decrease of the operational force of the disconnector.

Another aim of the invention is to provide a disconnection telescopic switch with a contact force obtained only by the elastic deformation of the fingers reduced aluminum section. The displacement of the reduced aluminum section fingers to the distances provided will result in a calculated force provided by the elastic deformation of the aluminum and sufficient for the expected current. Moving contact fingers are assembly pressure release elements, where the displacement of the finger determines the contact pressure.

Another aim of this invention is to provide a disconnection telescopic switch with adjustment of the total operating force of the contact, by precisely selecting the number of contact extensions and the pressure value of each contact extension.

Another aim of this invention is to provide the disconnection telescopic switch with capacity to the increase of the number of individual contact fingers, reducing the width of the separate section of each finger.

Another aim of this invention is to provide a disconnection telescopic switch with the possibility of adjustment to a higher current intensity, changing only the contact fingers and the contact plates. The contact plates of modular double-sided aluminum section of male and female connectors are normally over-measured, and a number of fingers is a limiting element of the disconnection switch; fingers from reduced aluminum section can be set to a higher transverse aluminum section and a greater contact force.

Another aim of this invention is to provide a disconnection telescopic switch with moving telescopic contacts for supplying pressure that have different lengths and gradually initiate physical contact with the fingers of the female lead connector, thus gradually and consecutively reducing the maximum mechanical forces.

This invention also intends to provide a telescopic disconnection switch a convective cooling of the moving contacts for supplying pressure and multiple contact plates of double-sided aluminum section, by the circulation of air through the spaces between the contact fingers and the contact plates.

This invention also intends to provide a telescopic disconnection switch a convective cooling of the moving contacts for supplying pressure and multiple contact plates of double-sided aluminum section, by the circulation of air through the spaces between the contact fingers and the contact plates. All the moving modular contact fingers and contact plates of the fixed conductors are attached to intermediate aluminum supports which will allow the distribution of electric current between them.

Another aim of this invention is to provide a telescopic disconnection switch with a spherical screw and a mechanical system of ball bearings that allow a low and constant operation force.

Another aim of this invention is to provide a disconnection telescopic switch with a limiting system of internal orbital displacement.

Another aim of this invention is to provide a disconnection telescopic switch with an orbital internal positioning system that will ensure the coaxial positioning of the moving contact after closing.

Another aim of this invention is to provide a disconnection telescopic switch with copper-free manufacturing and to allow a manufacturing fully free of aluminum welding by machining or extrusion of the core components.

Another aim of this invention is to provide a disconnection telescopic switch with adaptability to any type of busbar (bus) of isolated-phase. The machining of the male and female conducting bases of solid aluminum extrusions allows the manufacturing that adapts to the round or polygonal distribution bars (bus).

Another aim of this invention is to provide a disconnection telescopic switch with a manufacturing that uses material with relatively low magnetic permeability for the critical components of the system.

Another aim of this invention is to provide a disconnection telescopic switch with modular male and female conductors bearing the output pressure of the contact fingers from moving contacts.

These purposes and features are achieved by the modular telescopic disconnection switch of high voltage, isolated by the invention air, which comprises a modular manufacturing, the use of contact fingers from the aluminum reduced section, high operation accuracy, high adaptability to misalignments, adaptable and precisely calculated electric parameters (A/mm2, A/mm, A/kgf), useful contact area, constant and precise contact pressure, limited sliding contact, extensions of independent contacts, use of a floating pressure distribution, with a useful contact pressure, low approaching angles of minimum effort, high conductivity of the component materials, high efficiency of oxide removal during sliding movement, low stationary resistance of the contacts due to the use of solid silver.

### BRIEF DESCRIPTION OF THE FIGURES

FIG. 1a, is a perspective view of the telescopic switch from this invention in its closed position with isolators.

FIG. 1b, is a perspective view of a female lead connector from this invention with isolators.

FIG. 1c, is a perspective view of a male lead connector from this invention with isolators.

FIG. 1d, is a perspective view of the telescopic switch from this invention in its opened position with its isolators.

FIG. 1e, is a perspective view of the telescopic switch from this invention in its closed position.

FIG. 1f, is a perspective view of the telescopic switch from this invention in its opened position without its isolators.

FIG. 2, is a perspective view of the second lead connector of female configuration.

FIG. 3, is a perspective view of an intermediate section from the second lead connector in female configuration exemplifying the guide-positioning means.

FIG. 4, is a perspective view of the first lead connector of male configuration.

FIG. 5, is a perspective view of the first lead connector in female configuration exemplifying the guide-positioning means.

FIG. 6a, is a perspective view of the moving contact.

FIG. 6b, is a transverse view of the internal assembly of the moving contact.

FIG. 7, is a perspective view of the internal assembly of the moving contact.

FIG. 8, is a perspective view of the contact plate.

FIG. 9, is a perspective view of the mechanical system from this invention.

### DETAILED DESCRIPTION OF THE INVENTION

This invention refers to the construction of disconnection telescopic switches, to its maintenance, to its integration within the isolated phase busbars, to its weight, to the number of moving contacts and to the total number of electrical contacts.

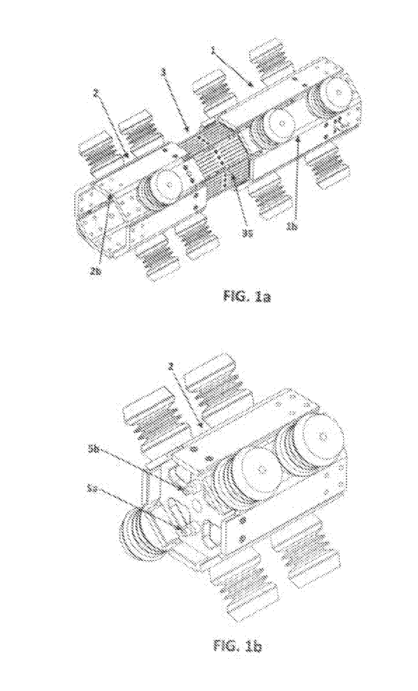

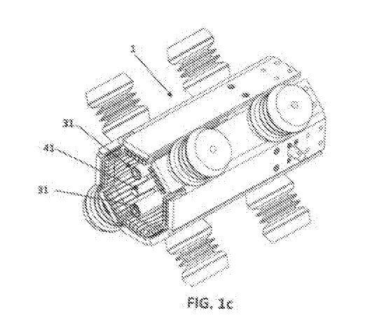

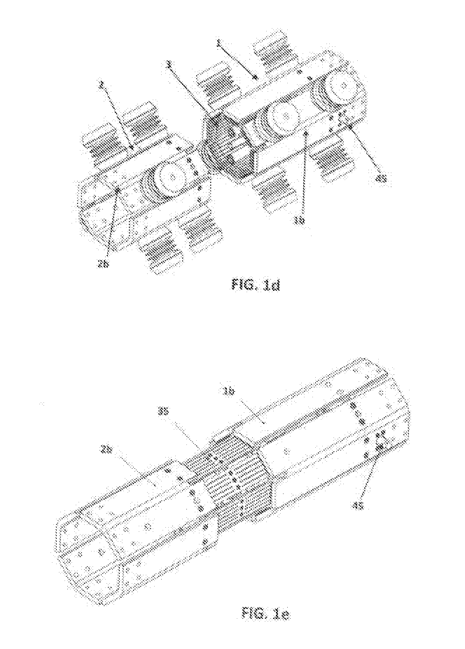

The moving contact systems of this invention are designed to supply a connection mechanism with to contact interfaces, a low resistance force and of operation precisely calculated. The moving contact of this invention is designed to be of a modular, polygonal construction with contact plates for the supply of independent forces. This invention provides a disconnection telescopic switch with sliding contacts, planes between the contact fingers and the moving contact. All of the contact assembly elements are designed to be manufactured by machining, extrusion or stamping and to supply a constructive assemblage solderless. The disconnection telescopic switch of this invention consists of a modular, polygonal female lead connector, a modular polygonal male lead connector, a moving contact for the provision of modular pressure and a mechanical system, as illustrated in FIG. 1.

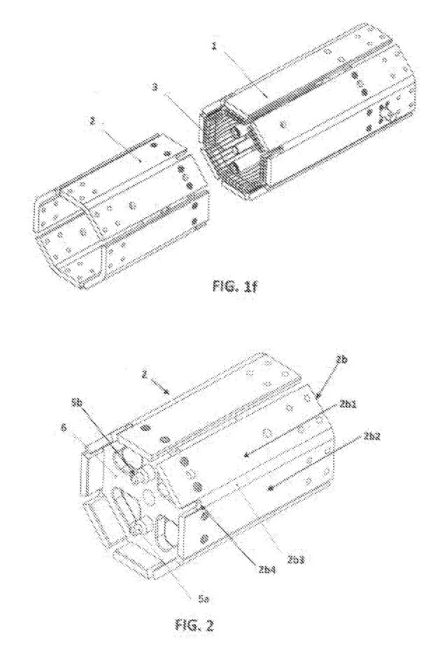

The modular female lead connector (2) consists of multiple contact plates (2b) of double-sided aluminum section, a removable intermediate plate (6) and a guide-positioning system (5). The contact plates (2b) of double-sided aluminum section are designed to be installed on a removable intermediate plate (6) with a shape of a regular polygon. The electrical contact is located at the front of the contact plate (2b) of double-sided aluminum section and it is designed in order not to present displacement, as illustrated in FIG. 2.

The guide-positioning system (5) consists of at least two guides (5a, 5b) which limit the displacement of a moving lead connector (3) and places such moving lead connector (3) in the middle of the female lead connector (2).

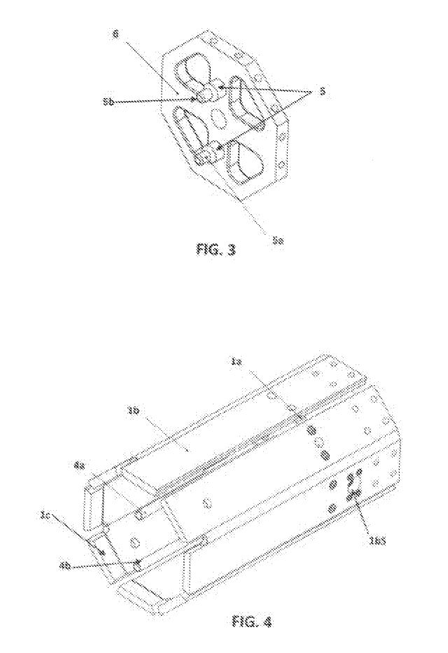

The guide-positioning system (5) is also installed on the removable intermediate plate (6), as illustrated in FIGS. 2 and 3.

The male lead connector (1) consists of multiple contact plates (1b) of double-sided aluminum section, a removable intermediate inner plate (1a) and a guide-positioning system (4). The contact plates (1b) of double-sided aluminum section are designed to be installed on a removable intermediate plate (1a) with a shape of a regular polygon, as illustrated in FIG. 4. The electrical contact is 10 located at the front of the contact plate (1b) of double-sided aluminum section and it is designed in order not to present displacement. The electrical contact (1c) of the male lead connector (1) is extended below the rest of the surfaces of the double-sided contact plate (1b) in order to allow the physical interaction with the moving contact of the moving connector only at the end of the displacement. The guide-positioning system (4) is manufactured with at least two guides (4a, 4b) which support the moving connector (3) during the displacement, where the aforementioned guide-positioning system (4) is installed on the removable intermediate plate (1a) of the male lead connector (1), and where such removable intermediate plate (1a) includes a bearing central bore (21), as illustrated in FIG. 5.

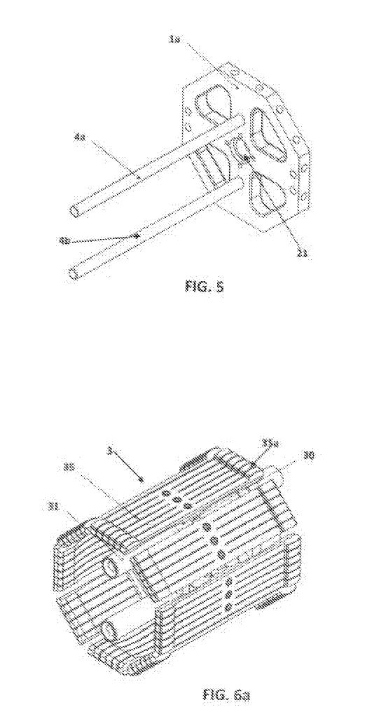

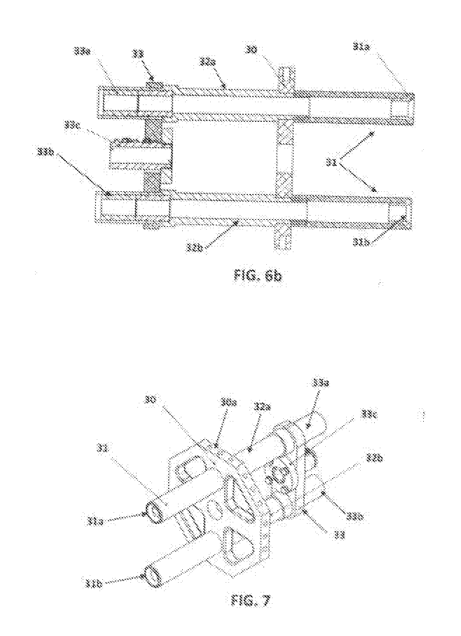

The moving connector (3) for the provision of pressure consists of contact fingers of reduced aluminum section formed in a contact plate (35) and of an intermediate support (30), such moving connector (3) for the provision of pressure also includes a sliding system as illustrated in FIG. 6a.

The intermediate support (30) has the shape of a regular polygon and has a number of sides consistent with those of the male lead connector (1) and of the female lead connector (2); likewise, the consistent sides have peripheral edges (30a) which, in turn, have coupling bores; such intermediate support (30) has at least two hubs (31a, 31b) designed to interact with the guide-positioning system (5) of the modular female lead connector (2) to place the moving connector (3) and to limit its displacement.

The intermediate support (30) binds itself coaxially and separately from a medium support (33) through the first longitudinal and hollow crossbar (32a), having each of those first (32b) and second (32b) longitudinal crossbars, a first end that has a top step that comes upon and constrains the coupling with the intermediate support (30), going through part of such first end the thickness of the already mentioned intermediate support (30), a second end that has a top step that comes upon and constrains the coupling with the medium support (33), going through part of the aforementioned second end the thickness of such medium support (33). The first end of each of the first (32a) and second (32b) longitudinal and hollow crossbars include in their final part a portion of junction through which a guiding support attaches (31), with such junction being either threaded or pressed; the second end of each of the first (32a) and second (32b) longitudinal and hollow crossbar include in their final part an extended portion for guide and joint, inside that extended portion for guide and joint there are sliding hubs (33a, 33b) which lead both guides (4a, 4b) that support the moving connector (3).

By means of which a guiding support attaches (31); likewise, the second first end includes, in its final part, a portion of the joint through which a guiding support is attached (31) (30). The intermediate support (30).

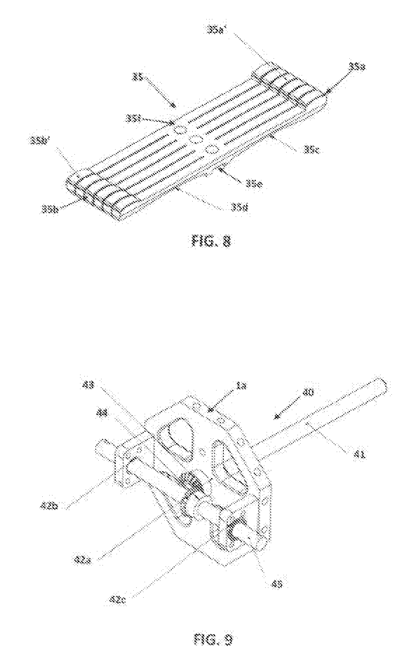

The medium support (33) includes a ball screw nut (33c) which is provided in the center of that medium support (33), as illustrated in FIG. 7. The intermediate support (30) of the moving connector (3) includes a plurality of contact plates (35) coupled in a decoupling way by means of a screw connection, and which include means of provision of pressure comprised of moving contact fingers of pressure supply (35a, 35b), which have two levels, a back section of the contact plate that is taller and which is designed to be in contact with the double-sided aluminum contact plate (1b) of the male lead connector (1) only at the end of the displacement, as illustrated in FIG. 8. Each of the contact plates (35) coupled to the moving connector (3) include in their longitudinal center a cross-slot (35e) placed in the lower part of the plate; likewise, in the top surface of the plate and at the same level, there is a plurality of coupling bores (35f); the contact fingers of the (35a) back section of the plate include a reduced section (35c), likewise the contact fingers (35b) of the front area of the plate include a reduced section (35d). The function of the cross-slot (35e) is to attach itself to the peripheral edges (30a) of the intermediate support (30) and to screw itself to it through the coupling bores.

The contact plates (1b, 2b) of double-sided aluminum section have a rigidity enough to support the contact pressure generated from the moving contact fingers for the provision of pressure (35a, 35b) of the moving connector (3), since each of those contact plates (1b, 2b) of double-sided aluminum section includes two contact plates (2b1, 2b2) coupled in only one piece, where the junction of those plates in just one piece is done through a longitudinal nerve (2b3) which has in one end an edge coinciding with the two plates and such longitudinal nerve (2b3) has in its other end a notch (2b4) placed near to the edges of the other two plates (2b1, 2b2). More specifically, the layout of the notch (2b4) is such that it is adjacent to the contact surfaces of each of the contact (1b, 2b) when they make contact with the moving contact fingers that provides pressure (35a, 35b).

The guide-positioning system (4) of the male lead connector (1) and the guide-positioning system (5) of the female lead connector (2) also function as systems for the delimitation of the displacement which consist of guide shafts made of stainless steel and are inserted with bronze placed orbitally within the male deal connector (1) and within the male deal connector (2).

The contact fingers (35a, 35b) of the moving connector (3) for the provision of pressure have two ball elevations, one front elevation (35b′) which is not as taller and designed to physically interact with the modular female lead connector (2), a rear elevation (35a′) which is taller that the front elevation (35b′) and it is designed to physically interact with the surfaces of the modular male lead connector (1). The elevations can be placed with the aim of starting the contact between the different pairs of the modular female (2) and male (1) lead connectors double-sided to reproduce the peak mechanical charges. The moving connector (3) for the provision of pressure and the contact plates (35) are designed to receive a silver plating.

In order to perform the movement of the modular moving contact (3) from a closed position to an opened position, the telescopic switch of this invention includes a mechanical system (40) placed within the first male deal connector (1) and coupled with a rear part of the inner removable intermediate plate (1a) from the aforementioned first male lead connector (1). The mechanical system (40) consists of a ball screw (41) consisting of a first end placed in a ball bearing (42a) mounted over the first bearing central bore (21) of the removable inner intermediate plate (1a); the ball screw (41) has such a length that it can take and move itself coaxially to the moving modular contact (3). The ending of the ball screw end (41) includes a first bevel gear (43) which mechanically attaches itself to a second bevel gear (44). One main shaft (45) is mounted on the bearings (42b, 42c), being those bearings coupled (42b, 42c) inside the first male lead connector (1) and in an inner surface of two of the double-sided plates (1b) by means of a main bore (1b5); such main shaft (45) is the one that transmits movement to the first bevel gear (43) of the ball screw (41) by means of a second bevel gear (44). The rotation of the main shaft (45) rotates the ball bearing (42a) and, therefore, displaces the moving connector (3), as illustrated in FIG. 9.

With the structural features of the switch from this invention, a convective cooling is achieved for the moving contacts for the provision of pressure and for the multiple contact plates of double-sided aluminum section, by the circulation of air through the spaces between the contact fingers and the contact plates.

The distance between the contact plates of the double-sided aluminum section is smaller than the distance between the contact surfaces of the moving connector (3) for the provision of pressure; the movement of the moving connector (3) will displace the contact finger to the requested distance and the loss of shape of the aluminum will provide the disconnection telescopic switch with the necessary contact force. The same thing applies to the finger of back contact of the modular male lead connector (1) in the movement end, the tallest section of the fixed contacts will displace the contact fingers and the electrical contact will take place.

1. A high voltage disconnection telescopic switch insulated by air with moving contact with pressure supply, which comprises:
a main male conductor (1) consisting of a first guide-positioner (4) internally coupled to that main male conductor (1) by an intermediate plate (1a), a plurality of plates of double-sided contact (1b) peripherically coupled to the intermediate plate border (1a);
a second female conductor (2) coaxially separated from the first male conductor (1) comprising a second guide-positioner means (5) internally coupled to such second female conductor (2) by an intermediate section (6), a plurality of plates of double-sided contact (1b) peripherically coupled to the intermediate section border (6);
a mobile conductor (3) consisting of guide means (31, 33a, 33b) internally coupled with that conductor (3) by an intermediate support (30), said mobile conductor (3) being coaxially copied to the interior of the first male conductor (1);
where such mobile conductor (3) moves between an open position, where such mobile conductor (3) is separated from the first male conductor (1), and a closed position where such mobile conductor (3) causes a contact between the first male conductor (1) and the second female conductor (2), by means of interacting among them from the first guide-positioner means (4) of the first male conductor (1), the second guide-positioner means (5) of the second female conductor (2) and the guide means (31, 33a, 33b) of the mobile conductor (3); and
a plurality of contact plates (35) peripherically coupled to the intermediate support border (30) of the moving conductor (3), each of the contact plates (35) having means for supplying pressure (35a, 35b).

2. A high voltage disconnection telescopic switch insulated by air with moving contact with pressure supply according to claim 1, characterized by pressure supply means in concordance with a plurality of contact fingers (35a, 35b).

3. A high voltage disconnection telescopic switch insulated by air with moving contact with pressure supply according to claim 1, characterized in that each of the plurality of the contact plates (35), which comprises a transverse groove (35e) arranged at the bottom of the plate, likewise, in the top surface of such plate and at the same height a plurality of coupling bores (35f).

4. A high voltage disconnection telescopic switch insulated by air with moving contact with pressure supply according to claim 2, characterized in that the contact fingers (35a, 35b) of reduced aluminum section cause the required elastic deformation for the given current.

5. A high voltage disconnection telescopic switch insulated by air with moving contact with pressure supply according to claim 2, characterized in that the contact fingers (35a) from the back of the plate consist of an aluminum reduced section (35c). Likewise, the contact fingers (35b) of the front of the plate comprise a reduced section (35d).

6. A high voltage disconnection telescopic switch insulated by air with moving contact with pressure supply according to claim 2, characterized in that the contact fingers (35a, 35b) are independent.

7. A high voltage disconnection telescopic switch insulated by air with moving contact with pressure supply according to claim 2, characterized in that the contact fingers (35a, 35b) of the moving contact for supplying pressure have two ball elevations (35a′, 35b′), one front lower elevation (35b′) which is designed to physically interact with the modular female contact (2), a higher back elevation (35a′) aimed to physically interact with the surfaces of the modular male conductor (1).

8. A high voltage disconnection telescopic switch insulated by air with moving contact with pressure supply according to claim 1, characterized in that the modular assembly of the female conductor, the male conductor and the moving contact allow the replacement of any part that may be subject to a catastrophic failure, without the removal of the isolated-phase bus switch.

9. A high voltage disconnection telescopic switch insulated by air with moving contact with pressure supply according to claim 2, characterized in that the contact fingers (35a, 35b) have structural features that may increase the number of individual contact fingers, reducing the width of the independent section of each finger; and which allows a high current adjustment that changes the dimension of such contact fingers (35a, 35b) for supplying pressure.

10. An air-insulated telescopic disconnection switch with moving contact for supplying pressure according to claim 2, characterized in that a convection cooling of moving contacts for supplying pressure and contact plates of multiple double-sided aluminum section is achieved, by the circulation of air through the spaces between the contact fingers and the contact plates.

11. An air-insulated telescopic disconnection switch with moving contact for supplying pressure according to claim 1, characterized in that the guide-positioner system (4) is made of at least two guides supporting the moving contacts (3) during sliding and mounted on the intermediate removable plate (1a).

12. An air-insulated telescopic disconnection switch with moving contact for supplying pressure according to claim 1, characterized in that the intermediate guide-positioner of the (4) male conductor (1) and the intermediate guide positioner (5) of the female conductor (2) have also the function of being sliding limiting systems, which are in accordance with stainless steel guide axes and bronze inserts orbitally arranged inside the male conductor (1) and the female conductor (2).

13. An air-insulated telescopic disconnection switch with moving contact for supplying pressure according to claim 1, characterized in that the contact plates (1b, 2b) of double-sided aluminum section have a rigidity enough to support the contact pressure generated from the moving contact fingers for the provision of pressure (35a, 35b) of the moving connector (3), since each of those contact plates (1b, 2b) of double-sided aluminum section includes two contact plates (2b1, 2b2) coupled in only one piece, where the junction of those plates in just one piece is done through a longitudinal nerve (2b3) which has in one end an edge coinciding with the two plates and such longitudinal nerve (2b3) has in its other end a notch (2b4) placed near to the edges of the other two plates (2b1, 2b2).

14. A high voltage air-insulated telescopic disconnection switch with moving contact for supplying pressure according to claim 11, characterized in that the layout of the notch (2b4) is arranged in such a way that it is adjacent to the contact surfaces of each of the contact plates (1b, 2b), when they make contact with moving contacts for supplying pressure (35a, 35b).

15. A high voltage air-insulated telescopic disconnection switch with moving contact for supplying pressure according to claim 1, characterized in that it comprises a mechanical system (40) arranged within the main male conductor (1) and coupled with the back part of the internal removable intermediate plate (1a) of such first male conductor (1), where such mechanical system (40) consists of a ball screw (41) comprising a first end arranged in a ball bearing (42a) mounted on a first rolling central bore (21) of the internal removable plate (1a); the ball screw (41) with a length that can lead and coaxially move the modular moving contact (3).
